(19) United States
(12) Patent Application Publication
(10) Pub. No.: US 2026/0360598 A1
(43) Pub. Date: Nov. 12, 2026

(54) BORON- AND SILICON-COATED METAL SOFT MAGNETIC POWDER CORE AND PREPARATION METHOD THEREFOR

(71) Applicant: HENGDIAN GROUP DMEGC MAGNETICS CO., LTD, Dongyang City Jinhua Zhejiang (CN)

(72) Inventors: Lingwen CAI, Dongyang Ciy (CN); Ning ZHANG, Dongyang City (CN); Jianping YANG, Dongyang City (CN); Jiangqun DONG, Dongyang City (CN); Daxin BAO, Dongyang City (CN)

(21) Appl. No.: 19/125,252

(22) PCT Filed: Oct. 30, 2023
(86) PCT No.: PCT/CN2023/127840

§ 371 Date: Apr. 28, 2025

(30) Foreign Application Priority Data
Oct. 28, 2022 (CN) 202211333448.6

(51) Int. Cl. H01F 1/26; H01F 27/255

(52) U.S. Cl. CPC H01F 1/26; H01F 27/255

(57) ABSTRACT

A boron- and silicon-coated metal soft magnetic powder core and a preparation method therefor. The preparation method comprises the following steps: (1) mixing a siloxane, boric acid powder, a first solvent, a catalyst, and water for a hydrolysis reaction, and carrying out a polycondensation reaction on the hydrolysate to obtain a boron- and silicon-containing coating agent; (2) mixing the boron- and silicon-containing coating agent, soft magnetic powder, and a second solvent to obtain coated soft magnetic powder; and (3) mixing the coated soft magnetic powder, a binder, and a release agent, and sequentially carrying out press molding and annealing treatment to obtain a boron- and silicon-coated metal soft magnetic powder core. According to the preparation method of the present application, the surface of soft magnetic powder is uniformly coated with a chemically organically synthesized boron- and silicon-containing coating, so as to effectively improve the insulative coating on the surface of the soft magnetic powder, thereby greatly improving the resistance of the metal soft magnetic powder core and reducing eddy current losses under high-frequency use. The present application has prospects for large-scale industrial popularization and application.

### TECHNICAL FIELD

Examples of the present application relate to the technical field of metal soft magnetic materials, such as a boron/silicon-coated metal soft magnetic powder core and a preparation method therefor.

### BACKGROUND

Soft magnetic materials is an important magnetic functional material with good electromagnetic energy conversion characteristics; the electronic components prepared therefrom are widely used in communications, power equipment, information technology, automatic control and other fields. Metal soft magnetic materials has the advantages of high saturation magnetization and good frequency characteristics. The metal soft magnetic materials can be coated and mixed with insulating binders, and subjected to the processes of molding, annealing treatment, and immersing and solidifying; the prepared metal soft magnetic powder cores can be used in high-frequency, high-energy efficiency, high-current, and miniaturized electronic components.

The surface coating of metal magnetic powder can improve the surface resistance of the powder core and reduce the eddy current loss in the high-frequency use. At present, the technology mainly focuses on coating silicon-containing compounds on the surface of magnetic particles by using methods such as inorganic coating, organic coating, and inorganic-organic coating.

CN110246679A disclosed a preparation method for metal soft magnetic powder cores based on an organic/inorganic composite insulation process, and the technical solution is as follows: firstly, epoxy resin is used to coat the metal magnetic powder by organic insulation coating, and then the epoxy resin and the silicon oxide nano-powder generated by the hydrolysis of tetraethyl orthosilicate are subjected to modification coupling with the silane coupling agent to realize the composite insulation of epoxy resin and silicon oxide on the metal magnetic powder, and on this basis, the insulated powder is cold-pressed and molded, and the green billet is annealed at high temperature to obtain the metal soft magnetic powder core with excellent DC bias performance and low high-frequency loss. However, the process is unable to satisfyingly improve the insulation between particles, and the magnetic loss of the obtained metal soft magnetic powder core is high.

CN101599334A disclosed a manufacturing method of an iron-silicon-aluminum material with high resistivity and high magnetic permeability. By adding 1-10 wt % Ni powder to the FeSiAl magnetic powder and coating the magnetic powder with a SiO₂ layer on the surface, the conductivity can be significantly reduced on the basis of not changing the original magnetic properties substantially, greatly reducing the loss. Moreover, the thickness of the SiO₂ coating layer can be adjusted according to the concentration of tetraethyl orthosilicate added. The method carries out surface treatment on the coating powder, improves the dispersion and processing performance of the product, and significantly improves the physical and chemical properties of the product. However, this method is difficult to perform and the process is not easy to control.

CN103247403A disclosed a preparation method for a metal soft magnetic powder core, which includes six parts: raw material screening, insulation coating, preparation of magnetic powder to be formed, pressing molding, heat treatment and surface spray-coating. The production process is simple, and the equipment used is simple; the nano-oxide dispersion liquid is used in insulation coating for the magnetic particles, which has good usage effect, no environmental pollution, and low raw material cost; no organic solvents or organic binders are used in the preparation process, and no immersion curing treatment is performed, which is low in cost and pollution-free; and the metal soft magnetic powder core prepared by the method has stable magnetic properties, high quality factor and low magnetic core loss. However, the coating effect of the preparation method is poor.

Therefore, it is of great significance to develop a boron/silicon-coated metal soft magnetic powder core and a preparation method therefor, which has a good insulation coating effect and can improve the surface resistance of the magnetic powder core and reduce the eddy current loss in the high-frequency use.

### SUMMARY

The following is a summary of subject matter that is described in detail herein. This summary is not intended to be limiting as to the scope of the claims.

An embodiment of the present application provides a boron/silicon-coated metal soft magnetic powder core and a preparation method therefor. The boron/silicon-containing coating substance obtained from chemical organic synthesis is used to uniformly coat the surface of the soft magnetic powder, the preparation process is easy to control, the insulation coating effect is good, and there is a promising application prospect of large-scale industrial production.

In a first aspect, an embodiment of the present application provides a preparation method for a boron/silicon-coated metal soft magnetic powder core, and the preparation method includes the following steps:
(1) mixing siloxane, boric acid powder, a first solvent, a catalyst and water, performing hydrolysis reaction, and subjecting the hydrolysate to polycondensation reaction to obtain a boron/silicon-containing coating agent;
(2) mixing the boron/silicon-containing coating agent, soft magnetic powder and a second solvent to obtain coated soft magnetic powder; and
(3) mixing the coated soft magnetic powder, a binder and a release agent, and performing press molding and annealing treatment in sequence to obtain a boron/silicon-coated metal soft magnetic powder core.

The preparation method of the boron/silicon-coated metal soft magnetic powder core described in the present application adopts the raw materials of siloxane, boric acid powder, the first solvent, the catalyst and water to carry out hydrolysis reaction and polycondensation reaction sequentially to obtain the boron/silicon-containing coating agent. The coating agent can form a glass network structure on the surface of soft magnetic powder particles. The insulation coating on the surface of soft magnetic powder is effectively improved, thereby greatly improving the resistance of the metal soft magnetic powder core, and reducing eddy current loss in the high-frequency use. The preparation method described in the present application has a controllable preparation process and gives good insulation coating effect.

Preferably, the process of mixing siloxane, boric acid powder, a first solvent, a catalyst and water in step (1) includes: first mixing siloxane and boric acid powder to obtain a mixed solution, then adding the first solvent and the catalyst, stirring and heating to 50-100 °C, and adding water, wherein the temperature of 50-100 °C under stirring and heating may be, for example, 50 °C, 60 °C, 70 °C, 80 °C, 90 °C or 100 °C, but is not limited to the listed values, and other unlisted values within the numerical range are also applicable.

Preferably, the siloxane in step (1) includes polydimethylsiloxane and/or diethoxydimethylsilane.

Preferably, a purity of the boric acid powder is more than or equal to 99.9%, which may be, for example, 99.9%, 99.91%, 99.92%, 99.94%, 99.95% or 99.98%, but is not limited to the listed values, and other unlisted values within the numerical range are also applicable.

Preferably, a particle size of the boric acid powder is 5-50 μm, which may be, for example, 5 μm, 10 μm, 20 μm, 30 μm, 40 μm or 50 μm, but is not limited to the listed values, and other unlisted values within the numerical range are also applicable.

Preferably, a mass ratio of the siloxane to the boric acid powder is 10:(0.5-3), which may be, for example, 10:0.5, 10:0.8, 10:1, 10:1.5, 10:2 or 10:3, but is not limited to the listed values, and other unlisted values within the numerical range are also applicable.

The mass ratio of siloxane to boric acid powder is preferably 10:(0.5-3) in the present application, which is conducive to the formation of a boron/silicon-containing coating substance with a glass network structure on the surface of the soft magnetic powder particles, thereby improving the surface resistance of the metal soft magnetic powder core and reducing the eddy current loss in the high-frequency use. When the mass ratio of siloxane to boric acid powder is less than 10:0.5, the silicon content of the powder coating substance will be too low, leading to poor reduction effect of eddy current loss. When the mass ratio of siloxane to boric acid powder is higher than 10:3, the silicon content of the powder coating substance will be too high, leading to greatly reduced magnetic permeability of the boron/silicon-coated metal soft magnetic powder core.

Preferably, the first solvent in step (1) includes any one or a combination of at least two of methanol, ethanol, isopropanol or n-butanol, wherein a typical but non-limiting combination includes a combination of methanol and ethanol, a combination of isopropanol and n-butanol, a combination of ethanol and isopropanol or a combination of n-butanol, methanol and isopropanol.

Preferably, the catalyst includes any one or a combination of at least two of hydrochloric acid, sulfuric acid or nitric acid, wherein a typical but non-limiting combination includes a combination of hydrochloric acid and sulfuric acid, a combination of nitric acid and hydrochloric acid or a combination of sulfuric acid, nitric acid and hydrochloric acid.

Preferably, a mass concentration of the catalyst is 2-10 mol/mL, which may be, for example, 2 mol/mL, 3 mol/mL, 5 mol/mL, 7 mol/mL, 8 mol/mL or 10 mol/mL, but is not limited to the listed values, and other unlisted values within the numerical range are also applicable.

Preferably, a volume ratio of the first solvent to the catalyst is 10:(0.1-0.5), which may be, for example, 10:0.1, 10:0.2, 10:0.3, 10:0.4 or 10:0.5, but is not limited to the listed values, and other unlisted values within the numerical range are also applicable.

Preferably, the water includes deionized water.

Preferably, an additive amount of the water is 1-5% of the mass of the siloxane and boric acid powder, which may be, for example, 1%, 2%, 3%, 4% or 5%, but is not limited to the listed values, and other unlisted values within the numerical range are also applicable.

Preferably, the hydrolysis reaction is performed for a period of 0.5-5 h, which may be, for example, 0.5 h, 1 h, 2 h, 3 h, 4 h or 5 h, but is not limited to the listed values, and other unlisted values within the numerical range are also applicable.

Preferably, the polycondensation reaction in step (1) is performed in a distillation device.

Preferably, the hydrolysate is subjected to reduced pressure distillation in the distillation device.

Preferably, the reduced pressure distillation is performed at a vacuum degree of 0.02-0.15 MPa, which may be, for example, 0.02 MPa, 0.05 MPa, 0.1 MPa, 0.12 MPa, 0.14 MPa or 0.15 MPa, but is not limited to the listed values, and other unlisted values within the numerical range are also applicable.

Preferably, the polycondensation reaction is performed at a temperature of 80-150 °C, which may be, for example, 80 °C, 90 °C, 100 °C, 130 °C, 140 °C or 150 °C, but is not limited to the listed values, and other unlisted values within the numerical range are also applicable.

Preferably, the polycondensation reaction is performed for a period of 1-20 h, which may be, for example, 1 h, 3 h, 5 h, 10 h, 15 h or 20 h, but is not limited to the listed values, and other unlisted values within the numerical range are also applicable.

Preferably, a mass ratio of the boron/silicon-containing coating agent, the soft magnetic powder and the second solvent is (0.01-0.5):10:(0.5-1.5), which may be, for example, 0.01:10:0.5, 0.05:10:0.8, 0.1:10:0.9, 0.2:10:1, 0.3:10:1.2 or 0.5:10:1.5, but is not limited to the listed values, and other unlisted values within the numerical range are also applicable.

Preferably, the soft magnetic powder includes any one or a combination of at least two of iron-nickel magnetic powder, iron-silicon magnetic powder, iron-silicon-aluminum magnetic powder, iron-nickel-molybdenum magnetic powder, amorphous magnetic powder or nanocrystalline magnetic powder, wherein a typical but non-limiting combination includes a combination of iron-nickel magnetic powder and iron-silicon magnetic powder, a combination of iron-silicon-aluminum magnetic powder and iron-nickel-molybdenum magnetic powder, a combination of iron-nickel magnetic powder and iron-silicon-aluminum magnetic powder or a combination of iron-nickel-molybdenum magnetic powder, iron-nickel magnetic powder and iron-silicon magnetic powder.

Preferably, the second solvent includes acetone.

Preferably, the coated soft magnetic powder is further subjected to drying and screening treatment sequentially.

Preferably, the process of mixing the coated soft magnetic powder, a binder and a release agent in step (3) includes first mixing the coated soft magnetic powder and the binder and then drying the same, and then adding the release agent.

Preferably, a mass ratio of the coated soft magnetic powder, the binder and the release agent is 10:(0.01-0.1):(0.01-0.1), which may be, for example, 10:0.01:0.01, 10:0.02:0.03, 10:0.05:0.05, 10:0.06:0.07, 10:0.08:0.09 or 10:0.1:0.1, but is not limited to the listed values, and other unlisted values within the numerical range are also applicable.

Preferably, the binder includes any one or a combination of at least two of silicone resin, epoxy resin or phenolic resin, wherein a typical but non-limiting combination includes a combination of silicone resin and epoxy resin, a combination of phenolic resin and silicone resin or a combination of epoxy resin, phenolic resin and silicone resin.

Preferably, the release agent includes any one or a combination of at least two of zinc stearate, aluminum stearate or graphite, wherein a typical but non-limiting combination includes a combination of zinc stearate and aluminum stearate, a combination of graphite and zinc stearate or a combination of aluminum stearate, graphite and zinc stearate.

Preferably, the press molding in step (3) is performed under a pressure of 1000-3000 MPa, which may be, for example, 1000 MPa, 1050 MPa, 2000 MPa, 2500 MPa or 3000 MPa, but is not limited to the listed values, and other unlisted values within the numerical range are also applicable.

The pressure of the press molding is preferably 1000-3000 MPa in the present application, which has the advantage of improving the compactness of the boron/silicon-coated metal soft magnetic powder core and protecting the insulating layer from damage.

Preferably, the annealing treatment is performed in nitrogen atmosphere.

Preferably, the annealing treatment is performed at a temperature of 500-800 °C, which may be, for example, 500 °C, 550 °C, 600 °C, 700 °C, 770 °C or 800 °C, but is not limited to the listed values, and other unlisted values within the numerical range are also applicable.

The temperature of the annealing treatment is preferably 500-800 °C in the present application, which has the advantage of removing stress and reducing hysteresis loss.

Preferably, the annealing treatment is performed for a period of 0.1-8 h, which may be, for example, 0.1 h, 0.5 h, 1 h, 2 h, 5 h or 8 h, but is not limited to the listed values, and other unlisted values within the numerical range are also applicable.

As a preferred technical solution in the present application, the preparation method includes the following steps:
(1) first mixing the siloxane and the boric acid powder according to a mass ratio of 10:(0.5-3) to obtain the mixed solution, then adding the first solvent and the catalyst with a volume ratio of 10:(0.1-0.5), stirring and heating to 50-100 °C, then adding water and performing hydrolysis reaction for 0.5-5 h; subjecting the hydrolysate to reduced pressure distillation in a distillation device, and performing polycondensation reaction at a temperature of 80-150 °C for 1-20 h to obtain the boron/silicon-containing coating agent;
wherein the siloxane includes polydimethylsiloxane and/or diethoxydimethylsilane; a purity of the boric acid powder is more than or equal to 99.9%; a particle size of the boric acid powder is 5-50 μm; the first solvent includes any one or a combination of at least two of methanol, ethanol, isopropanol or n-butanol; the catalyst includes any one or a combination of at least two of hydrochloric acid, sulfuric acid or nitric acid; a mass concentration of the catalyst is 2-10 mol/mL; the water includes deionized water; an additive amount of the water is 1-5 wt % of a mass of the siloxane and the boric acid powder; the reduced pressure distillation is performed at a vacuum degree of 0.02-0.15 MPa;
(2) mixing the boron/silicon-containing coating agent, the soft magnetic powder and the second solvent according to a mass ratio of (0.01-0.5):10:(0.5-1.5) to obtain the coated soft magnetic powder;
wherein the soft magnetic powder includes any one or a combination of at least two of iron-nickel magnetic powder, iron-silicon magnetic powder, iron-silicon-aluminum magnetic powder, iron-nickel-molybdenum magnetic powder, amorphous magnetic powder or nanocrystalline magnetic powder; the second solvent includes acetone; the coated soft magnetic powder is further subjected to drying and screening treatment sequentially; and
(3) first mixing the coated soft magnetic powder and the binder and then drying the same, then adding the release agent, and performing press molding under a pressure of 1000-3000 MPa and annealing treatment at a temperature of 500-800 °C for 0.1-8 h under nitrogen atmosphere sequentially to give the boron/silicon-coated metal soft magnetic powder core;
wherein a mass ratio of the coated soft magnetic powder, the binder and the release agent is 10:(0.01-0.1):(0.01-0.1); the binder includes any one or a combination of at least two of silicone resin, epoxy resin or phenolic resin; and the release agent includes any one or a combination of at least two of zinc stearate, aluminum stearate or graphite.

In a second aspect, an embodiment of the present application further provides a boron/silicon-coated metal soft magnetic powder core, and the metal soft magnetic powder core is prepared from the preparation method for a boron/silicon-coated metal soft magnetic powder core as described in the first aspect.

Compared with the prior art, embodiments of the present application have at least the following beneficial effects:
(1) the preparation method for a boron/silicon-coated metal soft magnetic powder core provided by an embodiment of the present application adopts the raw material of boric acid powder to carry out the chemical organic synthesis of boron/silicon-containing coating substance, which effectively improves the insulation coating on the surface of the metal soft magnetic powder core, and improves the resistance of the magnetic powder core; and
(2) the boron/silicon-coated metal soft magnetic powder core provided by an embodiment of the present application has superior magnetic properties, high magnetic permeability and low magnetic loss, and has a promising application prospect of large-scale industrial production.

Other aspects will be appreciated upon reading and understanding the detailed description.

### DETAILED DESCRIPTION

The embodiments of the present application are described below for ease of understanding the present application. It should be clear to those skilled in the art that the embodiments are merely used for a better understanding of the present application and should not be regarded as a specific limitation to the present application.

The present application is described in further detail below. However, the following embodiments are only simple examples of the present application and do not represent or limit the protection scope of the present application, and the protection scope of the present application is subject to the claims.

### Example 1

This example provides a preparation method for a boron/silicon-coated metal soft magnetic powder core, and the preparation method includes the following steps:
(1) firstly, polydimethylsiloxane and boric acid powder were mixed according to a mass ratio of 10:0.5 to obtain a mixed solution, then the mixed solution was added with a first solvent of ethanol and a catalyst of hydrochloric acid with a volume ratio of 10:0.3, stirred and heated to 50 °C, and then deionized water was added to carry out hydrolysis reaction for 0.5 h; the hydrolysate was subjected to reduced pressure distillation in a distillation device and polycondensation reaction at a temperature of 80 °C for 1 h to give a boron/silicon-containing coating agent;
the purity of the boric acid powder was 99.9%; the particle size of the boric acid powder was 30 μm; the mass concentration of the catalyst was 5 mol/mL; the additive amount of water was 2 wt % of the mass of siloxane and boric acid powder; the vacuum degree of the reduced pressure distillation was 0.02 MPa;
(2) the boron/silicon-containing coating agent, iron-nickel magnetic powder and a second solvent of acetone were mixed according to a mass ratio of 0.5:10:1 to give coated soft magnetic powder; the coated soft magnetic powder was subjected to drying and screening treatment sequentially; and
(3) the coated soft magnetic powder and a binder of silicone resin were firstly mixed, dried, and added with a release agent of zinc stearate, and subjected to press molding under a pressure of 1500 MPa and annealing treatment at a temperature of 600 °C for 5 h under nitrogen atmosphere sequentially, so as to give a boron/silicon-coated metal soft magnetic powder core; the mass ratio of the coated soft magnetic powder, the binder and the release agent was 10:0.05:0.05.

### Example 2

This example provides a preparation method for a boron/silicon-coated metal soft magnetic powder core, and the preparation method includes the following steps:
(1) firstly, polydimethylsiloxane and boric acid powder were mixed according to a mass ratio of 10:0.5 to obtain a mixed solution, then the mixed solution was added with a first solvent of ethanol and a catalyst of sulfuric acid with a volume ratio of 10:0.3, stirred and heated to 80 °C, and then deionized water was added to carry out hydrolysis reaction for 5 h; the hydrolysate was subjected to reduced pressure distillation in a distillation device and polycondensation reaction at a temperature of 100 °C for 1 h to give a boron/silicon-containing coating agent;
the purity of the boric acid powder was 99.93%; the particle size of the boric acid powder was 10 μm; the mass concentration of the catalyst was 2-10 mol/mL; the additive amount of water was 1-5 wt % of the mass of siloxane and boric acid powder; the vacuum degree of the reduced pressure distillation was 0.05 MPa;
(2) the boron/silicon-containing coating agent, iron-nickel magnetic powder and a second solvent of acetone were mixed according to a mass ratio of 0.05:10:1 to give coated soft magnetic powder; the coated soft magnetic powder was subjected to drying and screening treatment sequentially; and
(3) the coated soft magnetic powder and a binder of epoxy resin were firstly mixed, dried, and added with a release agent of aluminum stearate, and subjected to press molding under a pressure of 1500 MPa and annealing treatment at a temperature of 650 °C for 2 h under nitrogen atmosphere sequentially, so as to give a boron/silicon-coated metal soft magnetic powder core;
the mass ratio of the coated soft magnetic powder, the binder and the release agent was 10:0.01:0.05.

### Example 3

This example provides a preparation method for a boron/silicon-coated metal soft magnetic powder core, and the preparation method includes the following steps:
(1) firstly, polydimethylsiloxane and boric acid powder were mixed according to a mass ratio of 10:0.5 to obtain a mixed solution, then the mixed solution was added with a first solvent of ethanol and a catalyst of nitric acid with a volume ratio of 10:0.5, stirred and heated to 50 °C, and then deionized water was added to carry out hydrolysis reaction for 2 h; the hydrolysate was subjected to reduced pressure distillation in a distillation device and polycondensation reaction at a temperature of 80 °C for 1 h to give a boron/silicon-containing coating agent;
the purity of the boric acid powder was 99.95%; the particle size of the boric acid powder was 25 μm; the mass concentration of the catalyst was 4 mol/mL; the additive amount of water was 4 wt % of the mass of siloxane and boric acid powder; the vacuum degree of the reduced pressure distillation was 0.05 MPa;
(2) the boron/silicon-containing coating agent, iron-silicon magnetic powder and a second solvent of acetone were mixed according to a mass ratio of 0.05:10:1 to give coated soft magnetic powder; the coated soft magnetic powder was subjected to drying and screening treatment sequentially; and
(3) the coated soft magnetic powder and a binder of phenolic resin were firstly mixed, dried, and added with a release agent of graphite, and subjected to press molding under a pressure of 1500 MPa and annealing treatment at a temperature of 700 °C for 7 h under nitrogen atmosphere sequentially, so as to give a boron/silicon-coated metal soft magnetic powder core; the mass ratio of the coated soft magnetic powder, the binder and the release agent was 10:0.09:0.03.

### Example 4

This example provides a preparation method for a boron/silicon-coated metal soft magnetic powder core, and the preparation method includes the following steps:
(1) firstly, polydimethylsiloxane and boric acid powder were mixed according to a mass ratio of 10:0.5 to obtain a mixed solution, then the mixed solution was added with a first solvent of ethanol and a catalyst of sulfuric acid with a volume ratio of 10:0.5, stirred and heated to 50 °C, and then deionized water was added to carry out hydrolysis reaction for 5 h; the hydrolysate was subjected to reduced pressure distillation in a distillation device and polycondensation reaction at a temperature of 120 °C for 6 h to give a boron/silicon-containing coating agent;
the purity of the boric acid powder was more than or equal to 99.9%; the particle size of the boric acid powder was 50 μm; the mass concentration of the catalyst was 10 mol/mL; the additive amount of water was 2.4 wt % of the mass of siloxane and boric acid powder; the vacuum degree of the reduced pressure distillation was 0.1 MPa;
(2) the boron/silicon-containing coating agent, iron-silicon-aluminum magnetic powder and a second solvent of acetone were mixed according to a mass ratio of 0.05:10:1 to give coated soft magnetic powder; the coated soft magnetic powder was subjected to drying and screening treatment sequentially; and
(3) the coated soft magnetic powder and a binder of epoxy resin were firstly mixed, dried, and added with a release agent of zinc stearate, and subjected to press molding under a pressure of 1500 MPa and annealing treatment at a temperature of 700 °C for 5.5 h under nitrogen atmosphere sequentially, so as to give a boron/silicon-coated metal soft magnetic powder core; the mass ratio of the coated soft magnetic powder, the binder and the release agent was 10:0.08:0.01.

### Example 5

This example provides a preparation method for a boron/silicon-coated metal soft magnetic powder core, and the preparation method includes the following steps:
(1) firstly, diethoxydimethylsilane and boric acid powder were mixed according to a mass ratio of 10:3 to obtain a mixed solution, then the mixed solution was added with a first solvent of methanol and a catalyst of nitric acid with a volume ratio of 10:0.1, stirred and heated to 100 °C, and then deionized water was added to carry out hydrolysis reaction for 5 h; the hydrolysate was subjected to reduced pressure distillation in a distillation device and polycondensation reaction at a temperature of 150 °C for 20 h to give a boron/silicon-containing coating agent;
the purity of the boric acid powder was 99.92%; the particle size of the boric acid powder was 5 μm; the mass concentration of the catalyst was 2 mol/mL; the additive amount of water was 1 wt % of the mass of siloxane and boric acid powder; the vacuum degree of the reduced pressure distillation was 0.02 MPa;
(2) the boron/silicon-containing coating agent, iron-silicon magnetic powder and a second solvent of acetone were mixed according to a mass ratio of 0.01:10:0.5 to give coated soft magnetic powder; the coated soft magnetic powder was subjected to drying and screening treatment sequentially; and
(3) the coated soft magnetic powder and a binder of silicon resin were firstly mixed, dried, and added with a release agent of aluminum stearate, and subjected to press molding under a pressure of 1000 MPa and annealing treatment at a temperature of 500 °C for 8 h under nitrogen atmosphere sequentially, so as to give a boron/silicon-coated metal soft magnetic powder core; the mass ratio of the coated soft magnetic powder, the binder and the release agent was 10:0.01:0.1.

### Example 6

This example provides a preparation method for a boron/silicon-coated metal soft magnetic powder core, and the preparation method includes the following steps:
(1) firstly, polydimethylsiloxane and boric acid powder were mixed according to a mass ratio of 10:0.5 to obtain a mixed solution, then the mixed solution was added with a first solvent of ethanol and a catalyst of sulfuric acid with a volume ratio of 10:0.5, stirred and heated to 80 °C, and then deionized water was added to carry out hydrolysis reaction for 0.5 h; the hydrolysate was subjected to reduced pressure distillation in a distillation device and polycondensation reaction at a temperature of 80 °C for 1 h to give a boron/silicon-containing coating agent;
the purity of the boric acid powder was 99.98%; the particle size of the boric acid powder was 50 μm; the mass concentration of the catalyst was 10 mol/mL; the additive amount of water was 5 wt % of the mass of siloxane and boric acid powder; the vacuum degree of the reduced pressure distillation was 0.15 MPa;
(2) the boron/silicon-containing coating agent, iron-silicon-aluminum magnetic powder and a second solvent of acetone were mixed according to a mass ratio of 0.5:10:1.5 to give coated soft magnetic powder; the coated soft magnetic powder was subjected to drying and screening treatment sequentially; and
(3) the coated soft magnetic powder and a binder of silicon resin were firstly mixed, dried, and added with a release agent of zinc stearate, and subjected to press molding under a pressure of 3000 MPa and annealing treatment at a temperature of 800 °C for 0.1 h under nitrogen atmosphere sequentially, so as to give a boron/silicon-coated metal soft magnetic powder core; the mass ratio of the coated soft magnetic powder, the binder and the release agent was 10:0.1:0.5.

### Example 7

This example provides a preparation method for a boron/silicon-coated metal soft magnetic powder core, and the preparation method is the same as that in Example 1 except that the mass ratio of siloxane and boric acid powder in step (1) was changed from 10:0.5 to 10:0.1.

### Example 8

This example provides a preparation method for a boron/silicon-coated metal soft magnetic powder core, and the preparation method is the same as that in Example 1 except that the mass ratio of siloxane and boric acid powder in step (1) was changed from 10:0.5 to 10:4.

### Example 9

This example provides a preparation method for a boron/silicon-coated metal soft magnetic powder core, and the preparation method is the same as that in Example 1 except that the pressure of press molding in step (3) was changed from 1500 MPa to 500 MPa.

### Example 10

This example provides a preparation method for a boron/silicon-coated metal soft magnetic powder core, and the preparation method is the same as that in Example 1 except that the pressure of press molding in step (3) was changed from 1500 MPa to 3500 MPa.

### Example 11

This example provides a preparation method for a boron/silicon-coated metal soft magnetic powder core, and the preparation method is the same as that in Example 1 except that the temperature of annealing treatment in step (3) was changed from 600 °C to 400 °C.

### Example 12

This example provides a preparation method for a boron/silicon-coated metal soft magnetic powder core, and the preparation method is the same as that in Example 1 except that the temperature of annealing treatment in step (3) was changed from 600 °C to 900 °C.

### Comparative Example 1

This example provides a preparation method for a boron/silicon-coated metal soft magnetic powder core, and the preparation method includes the following steps:

The 500 mesh iron-nickel magnetic powder was passivated in phosphoric acid, and 0.5 wt % kaolin was added for insulation coating, and then 0.3 wt % silicone resin was added for secondary coating. Phenolic resin was added as a binder and zinc stearate was added as a release agent to the coated magnetic powder, and then the mixture was subjected to press molding under a pressure of 1500 MPa and annealing at a temperature of 600 °C under nitrogen atmosphere to give a ring sample.

### Comparative Example 2

This comparative example provides a preparation method for a boron/silicon-coated metal soft magnetic powder core, and the preparation method is the same as that in Example 1 except that the boric acid powder was not added in step (1).

### Comparative Example 3

This example provides a preparation method for a boron/silicon-coated metal soft magnetic powder core, and the preparation method is the same as that in Comparative Example 1 except that the iron-nickel magnetic powder was replaced with iron-silicon magnetic powder.

### Comparative Example 4

This example provides a preparation method for a boron/silicon-coated metal soft magnetic powder core, and the preparation method is the same as that in Comparative Example 1 except that the iron-nickel magnetic powder was replaced with iron-silicon-aluminum magnetic powder. Results of the magnetic permeability and magnetic loss of the boron/silicon-coated metal soft magnetic powder cores obtained from the above Examples and Comparative Examples are shown in Table 1.

TABLE 1

| | | Loss Pcv | Loss Pcv |
|---|---|---|---|
| | | (mW/cm³) | (mW/cm³) |
| | μ | (50 kHz, 100 mT) | (100 kHz, 100 mT) |
| Example 1 | 128 | 123 | 279 |
| Example 2 | 125 | 133 | 287 |
| Example 3 | 84 | 594 | 1356 |
| Example 4 | 60 | 132 | 272 |
| Example 5 | 56 | 749 | 1783 |
| Example 6 | 82 | 104 | 195 |
| Example 7 | 103 | 121 | 270 |
| Example 8 | 132 | 239 | 506 |
| Example 9 | 76 | 217 | 446 |
| Example 10 | 141 | 276 | 786 |
| Example 11 | 114 | 189 | 441 |
| Example 12 | 129 | 360 | 1210 |
| Comparative Example 1 | 115 | 171 | 404 |
| Comparative Example 2 | 124 | 303 | 919 |
| Comparative Example 3 | 54 | 935 | 2191 |
| Comparative Example 4 | 57 | 234 | 497 |

As can be seen from Table 1:
(1) from Examples 1-6, it can be seen that when the raw material is iron-nickel magnetic powder, the magnetic permeability of the obtained boron/silicon-coated metal soft magnetic powder core can reach more than or equal to 125, and the loss can reach less than or equal to 133 mW/cm³ under the conditions of 50 kHz and 100 mT, and the loss can reach less than or equal to 287 mW/cm³ under the conditions of 100 kHz and 100 mT; when the raw material is iron-silicon magnetic powder, the magnetic permeability of the obtained boron/silicon-coated metal soft magnetic powder core can reach more than or equal to 56, and the loss can reach less than or equal to 749 mW/cm³ under the conditions of 50 kHz and 100 mT, and the loss can reach less than or equal to 1783 mW/cm³ under the conditions of 100 kHz and 100 mT; when the raw material is iron-silicon-aluminum magnetic powder, the magnetic permeability of the obtained boron/silicon-coated metal soft magnetic powder core can reach more than or equal to 60, and the loss can reach less than or equal to 132 mW/cm³ under the conditions of 50 kHz and 100 mT, and the loss can reach less than or equal to 272 mW/cm³ under the conditions of 100 kHz and 100 mT;
(2) from Example 1 and Examples 7-8, it can be seen that the mass ratio of siloxane and boric acid powder in step (1) of Example 7 is 10:0.1, and the magnetic permeability of the obtained boron/silicon-coated metal soft magnetic powder core is significantly reduced compared with that of Example 1; but under the conditions of 50 kHz, 100 mT or under the conditions of 100 kHz, 100 mT, the loss is comparable to that of Example 1; the mass ratio of siloxane and boric acid powder in step (1) of Example 8 is 10:4, and the magnetic permeability of the obtained boron/silicon-coated metal soft magnetic powder core is 132, the magnetic permeability is slightly improved, but the loss is significantly increased;
(3) from Example 1 and Examples 9-10, it can be seen that the pressure of press molding in step (3) of Example 9 is low, and the magnetic permeability of the obtained boron/silicon-coated metal soft magnetic powder core (which is 76) is low; the pressure of press molding in step (3) of Example 10 is high, and the magnetic permeability of the obtained boron/silicon-coated metal soft magnetic powder core (which is 141) is higher than that of Example 1; but the losses of boron/silicon-coated metal soft magnetic powder cores obtained in Examples 9 and 10 are much higher than that in Example 1;
(4) from Example 1 and Examples 11-12, it can be seen that the temperature of annealing treatment in step (3) of Example 11 is low, and the magnetic permeability of the obtained boron/silicon-coated metal soft magnetic powder core is slightly lower than that of Example 1, but the loss is much higher than that of Example 1; the temperature of annealing treatment in step (3) of Example 12 is high, and the magnetic permeability of the obtained boron/silicon-coated metal soft magnetic powder core is comparable to that of Example 1, but under the conditions of 100 kHz and 100 mT, the loss is as high as 1210 mW/cm³;
(5) from the comparison between Example 1 and Comparative Example 1, Examples 3 and 5 and Comparative Example 3, and Examples 4 and 6 and Comparative Example 4, it can be seen that compared with the methods of Comparative Example 1, Comparative Example 3 and Comparative Example 4, when the preparation method for a boron/silicon-coated metal soft magnetic powder core provided in the present application is applied to the raw materials of iron-nickel magnetic powder, iron-silicon magnetic powder, iron-silicon-aluminum magnetic powder, the obtained boron/silicon-coated metal soft magnetic powder cores have high magnetic permeability and low loss; and
(6) from Example 1 and Comparative Example 2, it can be seen that boric acid powder is not added in step (1) of Comparative Example 2, and the magnetic permeability of the obtained metal soft magnetic powder core is slightly lower than that of Example 1, but the loss is much higher than that of Example 1.

In summary, the preparation method of a boron/silicon-coated metal soft magnetic powder core provided in the present application adopts a specific mass ratio of siloxane and boric acid powder, a specific pressure of press molding and a specific temperature of annealing treatment, and uses the raw material boric acid powder in chemical organic synthesis to give a boron/silicon-containing coating substance, which effectively improves the insulation coating on the surface of the metal soft magnetic powder core, and improves the resistance of the magnetic powder core; and the obtained boron/silicon-coated metal soft magnetic powder core has superior magnetic properties, high magnetic permeability and low magnetic loss.

The applicant declares that the above description is merely the specific embodiments of the present application, but the present application is not limited to the above examples. Those skilled in the art should understand that any changes or replacements that can be easily conceived within the scope of the technology disclosed by the present application shall fall within the protection scope and disclosure scope of the present application.

1. A preparation method for a boron/silicon-coated metal soft magnetic powder core, comprising the following steps:
(1) mixing siloxane, boric acid powder, a first solvent, a catalyst and water, performing hydrolysis reaction, and subjecting hydrolysate to polycondensation reaction to obtain a boron/silicon-containing coating agent;
(2) mixing the boron/silicon-containing coating agent, soft magnetic powder and a second solvent to obtain coated soft magnetic powder; and
(3) mixing the coated soft magnetic powder, a binder and a release agent, and performing press molding and annealing treatment in sequence to obtain a boron/silicon-coated metal soft magnetic powder core.

2. The preparation method according to claim 1, wherein the process of mixing siloxane, boric acid powder, a first solvent, a catalyst and water in step (1) comprises: first mixing the siloxane and the boric acid powder to obtain a mixed solution, then adding the first solvent and the catalyst, stirring and heating to 50-100 °C, and adding water.

3. The preparation method according to claim 1, wherein the siloxane in step (1) comprises polydimethylsiloxane and/or diethoxydimethylsilane.

4. The preparation method according to claim 1, wherein a purity of the boric acid powder is more than or equal to 99.9%.

5. The preparation method according to claim 1, wherein a particle size of the boric acid powder is 5-50 μm.

6. The preparation method according to claim 1, wherein a mass ratio of the siloxane to the boric acid powder is 10:(0.5-3).

7. The preparation method according to claim 1, wherein the first solvent in step (1) comprises any one or a combination of at least two of methanol, ethanol, isopropanol or n-butanol;
preferably, the catalyst comprises any one or a combination of at least two of hydrochloric acid, sulfuric acid or nitric acid;
preferably, a mass concentration of the catalyst is 2-10 mol/mL;
preferably, a volume ratio of the first solvent to the catalyst is 10:(0.1-0.5);
preferably, the water comprises deionized water;
preferably, an additive amount of the water is 1-5 wt % of a mass of the siloxane and the boric acid powder;
preferably, the hydrolysis reaction is performed for a period of 0.5-5 h.

8. The preparation method according to claim 1, wherein the polycondensation reaction in step (1) is performed in a distillation device;
preferably, the hydrolysate is subjected to reduced pressure distillation in the distillation device;
preferably, the reduced pressure distillation is performed at a vacuum degree of 0.02-0.15 MPa;
preferably, the polycondensation reaction is performed at a temperature of 80-150 °C;
preferably, the polycondensation reaction is performed for a period of 1-20 h.

9. The preparation method according to claim 1, wherein a mass ratio of the boron/silicon-containing coating agent, the soft magnetic powder and the second solvent is (0.01-0.5):10:(0.5-1.5);
preferably, the soft magnetic powder comprises any one or a combination of at least two of iron-nickel magnetic powder, iron-silicon magnetic powder, iron-silicon-aluminum magnetic powder, iron-nickel-molybdenum magnetic powder, amorphous magnetic powder or nanocrystalline magnetic powder;
preferably, the second solvent comprises acetone;
preferably, the coated soft magnetic powder is further subjected to drying and screening treatment sequentially.

10. The preparation method according to claim 1, wherein the process of mixing the coated soft magnetic powder, a binder and a release agent in step (3) comprises: first mixing the coated soft magnetic powder and the binder and then drying the same, and then adding the release agent;
preferably, a mass ratio of the coated soft magnetic powder, the binder and the release agent is 10:(0.01-0.1):(0.01-0.1);
preferably, the binder comprises any one or a combination of at least two of silicone resin, epoxy resin or phenolic resin;
preferably, the release agent comprises any one or a combination of at least two of zinc stearate, aluminum stearate or graphite.

11. The preparation method according to claim 1, wherein the press molding in step (3) is performed under a pressure of 1000-3000 MPa;
preferably, the annealing treatment is performed in nitrogen atmosphere;
preferably, the annealing treatment is performed at a temperature of 500-800 °C;
preferably, the annealing treatment is performed for a period of 0.1-8 h.

12. The preparation method according to claim 1, which comprises the following steps:
(1) first mixing the siloxane and the boric acid powder according to a mass ratio of 10:(0.5-3) to obtain the mixed solution, then adding the first solvent and the catalyst with a volume ratio of 10:(0.1-0.5), stirring and heating to 50-100 °C, then adding water and performing hydrolysis reaction for 0.5-5 h; subjecting the hydrolysate to reduced pressure distillation in a distillation device, and performing polycondensation reaction at a temperature of 80-150 °C for 1-20 h to obtain the boron/silicon-containing coating agent;
wherein the siloxane comprises polydimethylsiloxane and/or diethoxydimethylsilane; a purity of the boric acid powder is more than or equal to 99.9%; a particle size of the boric acid powder is 5-50 μm; the first solvent comprises any one or a combination of at least two of methanol, ethanol, isopropanol or n-butanol; the catalyst comprises any one or a combination of at least two of hydrochloric acid, sulfuric acid or nitric acid; a mass concentration of the catalyst is 2-10 mol/mL; the water comprises deionized water; an additive amount of the water is 1-5 wt % of a mass of the siloxane and the boric acid powder; the reduced pressure distillation is performed at a vacuum degree of 0.02-0.15 MPa;
(2) mixing the boron/silicon-containing coating agent, the soft magnetic powder and the second solvent according to a mass ratio of (0.01-0.5):10:(0.5-1.5) to obtain the coated soft magnetic powder;
wherein the soft magnetic powder comprises any one or a combination of at least two of iron-nickel magnetic powder, iron-silicon magnetic powder, iron-silicon-aluminum magnetic powder or iron-nickel-molybdenum magnetic powder; the second solvent comprises acetone; the coated soft magnetic powder is further subjected to drying and screening treatment sequentially; and
(3) first mixing the coated soft magnetic powder and the binder and then drying the same, then adding the release agent, and performing press molding under a pressure of 1000-3000 MPa and annealing treatment at a temperature of 500-800 °C for 0.1-8 h under nitrogen atmosphere sequentially to give the boron/silicon-coated metal soft magnetic powder core;
wherein a mass ratio of the coated soft magnetic powder, the binder and the release agent is 10:(0.01-0.1):(0.01-0.1); the binder comprises any one or a combination of at least two of silicone resin, epoxy resin or phenolic resin; and the release agent comprises any one or a combination of at least two of zinc stearate, aluminum stearate or graphite.

13. A boron/silicon-coated metal soft magnetic powder core, which is prepared from the preparation method for a boron/silicon-coated metal soft magnetic powder core according to claim 1.
